(19) United States
(12) Patent Application Publication
(10) Pub. No.: US 2011/0048332 A1
(43) Pub. Date: Mar. 3, 2011

(54) Aquarium Backlight

(76) Inventor: Sang Soo Lee, Fayetteville, NC (US)

(21) Appl. No.: 12/550,746

(22) Filed: Aug. 31, 2009

(51) Int. Cl. A01K 63/06; A01K 63/00

(52) U.S. Cl. 119/253; 119/267

(57) ABSTRACT

This invention is an illumination apparatus for an aquarium. In particular, the invention illuminates the back wall of the aquarium where the wall has a decorative panel of scenery. The illumination apparatus may be used in aquariums, terrariums, or similar enclosures. The illumination apparatus of the present invention allows for the use of filtration systems and other caretaking systems on the same wall as the illumination apparatus. The present invention uniformly illuminates the decorative panel and the aquarium, providing a pleasing effect.

### BACKGROUND

1. Field of Invention

This invention relates to an illumination apparatus for an aquarium. In particular, the invention illuminates the back wall of the aquarium where the wall has a decorative panel of scenery. The illumination apparatus may be used in aquariums, terrariums, or similar enclosures. The illumination apparatus of the present invention allows for the use of filtration systems and other caretaking systems on the same wall as the illumination apparatus. The present invention uniformly illuminates the decorative panel and the aquarium, providing a pleasing effect.

2. Brief Description of the Prior Art

Aquariums, terrariums, and other enclosures with transparent walls have been illuminated in a variety of ways. In addition to the traditional lighting provided from a housing that is placed on top of the aquarium, attachments to the walls of the aquarium that provide illumination have been described. Illumination provides a pleasing appearance to the contents of the aquarium, terrarium, or other enclosures.

Presently, no illumination apparatus provides adequate lighting throughout the back wall of an aquarium, terrarium, or similar enclosure to brighten a decorative background attached to the wall while maintaining a minimal thickness so a water filter (or other necessary apparatus) may be installed on the same wall. There is a need for an illumination apparatus that is cost-effective, easy to install, and illuminates a decorative background scene in a uniform and pleasing manner. The present invention addresses these needs. As will be seen from the subsequent description, the preferred embodiment of the present invention overcomes these and other shortcomings of the prior art.

### SUMMARY OF THE INVENTION

Many owners of aquariums, terrariums, and similar enclosures find it aesthetically pleasing to place a decorative scene on the back wall (or another wall) of the container. These decorative scenes are readily available, and easy to install. One applied the decorative background, though semi-opaque in nature, may be difficult to view due to inadequate illumination from behind the wall. Traditional overhead lighting provided by a light within the lid of the enclosure is insufficient. Moreover, illumination provided by an ordinary lamp or daylight is not optimal due to availability and non-uniform distribution of illumination.

An apparatus that provides uniformly distributed light throughout the back wall containing the decorative scene is needed to adequately view the scene and lend a pleasing aesthetic to the enclosure. Previous attempts to address this issue describe an apparatus utilizing top-down illumination and reflective material, which do not achieve the desired effect of strong illumination (see U.S. application Ser. No. 11/953,299). Moreover, a triangular-shaped apparatus using an illumination source at the top of the apparatus, and reflective material below, does not accommodate the needs of a water filter where the apparatus is used with an aquarium. The large thickness of the light prevents the water filter from being able to be installed on the same wall.

The present system uses lighting distributed behind the back wall containing decorative scene to accomplish this task. Because the illumination source is located behind the wall of the enclosure (and not at the top), the thickness of the apparatus can be manipulated to allow for the use of a water filter, or other needed device, on the same wall. Moreover, the present invention is easy to install and cost-efficient, making it available to the everyday aquarium, terrarium, or similar enclosure hobbyist.

The present invention is an illuminating apparatus that may be attached to an aquarium, terrarium, or similar enclosure to provide background illumination to a decorative scene in the enclosure. The walls creating the housing of the illuminating apparatus may be constructed from separate parts such as a separate piece for the back wall of the apparatus and separate sidewall pieces. Alternatively, the walls creating the housing of the apparatus may be made as one contiguous piece. The illuminating apparatus may be constructed of plastics, polymers, fiberglass, epoxies, resins, polycarbonates, molding compounds, glues, woods, metals, glass and the like.

In one example, the housing of the illuminating apparatus is comprised of a back wall that has a reflective material affixed to the inner side, four side walls, which also have a reflective material affixed to the inner side and are connected to the back wall of the aquarium, terrarium, or similar enclosure. Each of the four corners is rounded so as to provide optimal reflection. Variations in thickness of the back wall to the wall of the aquarium, terrarium, or similar enclosure to accommodate filtration systems and the like are also rounded.

A light source is attached to the back wall of the illumination apparatus. The light source is of a substantial size, so as to provide uniform illumination to the back wall of the aquarium, terrarium, or similar enclosure. The apparatus is equipped with hooks or other fastening means to attach to the top of the back wall of the aquarium, terrarium, or other enclosure.

When attached, the four sidewalls of the illumination apparatus are in contact with the four sides of the wall of the aquarium, terrarium, or other similar enclosure to which the illumination apparatus is attached. The illumination apparatus can be connected to the back wall, or other desired wall of the aquarium, terrarium, or similar enclosure. Moreover, the illumination apparatus may be adapted such that a filtration system may also be affixed to the same wall as the illumination apparatus without conflict. Still other modifications and positions of these elements may be implemented, as will be apparent to one skilled in the art.

The present invention is very affordable and easy to implement. The illumination apparatus of the present invention may be made of inexpensive, durable, and easy to maintain materials.

Size and shape of the illumination apparatus may be customized so that it is substantially the same size and shape as the wall of the aquarium, terrarium, or similar enclosure to which the illumination apparatus will be affixed. For example, a rectangular shape, like a traditional aquarium, is contemplated, but other shapes such as squares, ovals, parallelograms, circles, and the like are also contemplated. As stated above, the thickness (as measured from the back wall of the illumination apparatus to the wall of the aquarium, terrarium, or similar enclosure to which it is attached) of the apparatus may vary. The thickness may be not uniform, having a thinner portion, so that a filter, commonly used in aquariums, may be attached to the same wall as the apparatus.

The thickness of the illumination apparatus, from the back wall of the apparatus to the wall of the aquarium, terrarium, or similar enclosure, will vary depending on the type of illumination source. For example, where a very thin illumination source (such as LED, or plasma), is used, the illumination apparatus will be very thin.

One object of the present invention is to provide a cost effective, easy to install illumination apparatus to illuminate a wall of an aquarium, terrarium, or similar enclosure having a decorative scene on the wall.

It is a further object of the present invention to provide a pleasing aesthetic to an aquarium, terrarium, or similar enclosure by providing backlight to a decorative scene therein.

It is a further object of the present invention to provide an illumination apparatus that allows for the use of a filtration system (or similar apparatus used for the care of the enclosure) in conjunction with the illumination apparatus without conflict.

Still other aspects of the present invention will become apparent to those skilled in the art from the following description of a preferred embodiment, which is by way of illustration, one of the best modes contemplated for carrying out the invention. As will be realized, the invention is capable of other different and obvious aspects, all without departing from the invention. Accordingly, the drawings and descriptions are illustrative in nature and not restrictive.

### DESCRIPTION OF THE DRAWINGS

The foregoing aspects and many of the accompanying advantages of this invention will become more readily appreciated as the same becomes understood by reference to the following detailed description, when taken in conjunction with the accompanying drawings, wherein:

FIG. 1 is cross-section view of the illumination apparatus installed on an aquarium, according to one preferred embodiment of the present invention.

FIG. 2 is a frontal view of an uninstalled illumination apparatus according to one embodiment of the present invention.

FIG. 3 is another cross-sectional rendering of the illumination apparatus installed on an aquarium without a filter, according to one embodiment of the present invention.

FIG. 4 is a rendering of the back wall of the housing of the illumination apparatus, showing the curved edges and variation in thickness to support a water filter, as in one embodiment of the present invention.

### DETAILED DESCRIPTION

The detailed explanation of the present invention is described below. The described preferred embodiments are presented for the purpose of illustration and description; they are not intended to limit the scope of the present invention. As will be apparent to one skilled in the art, modifications to described elements below may be made without deviating from the scope of the present invention.

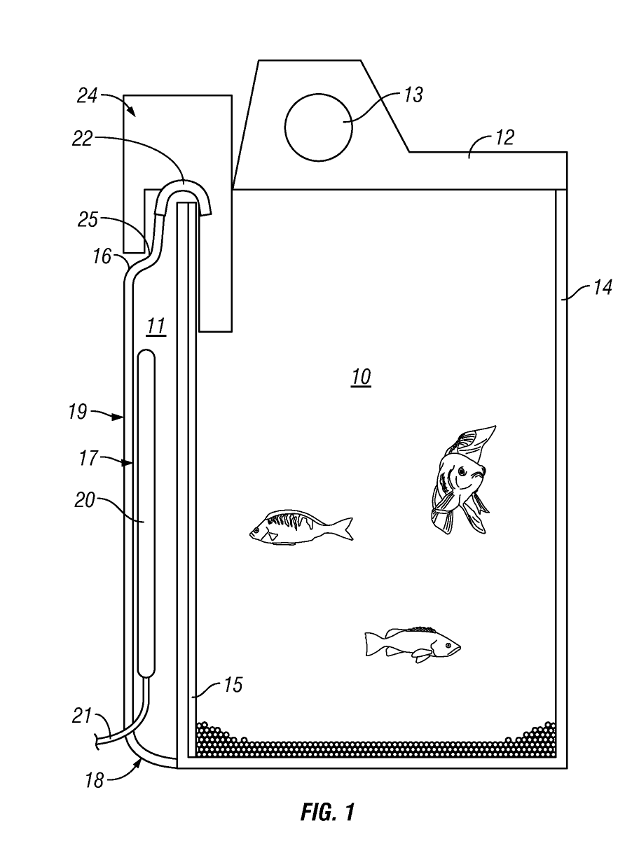

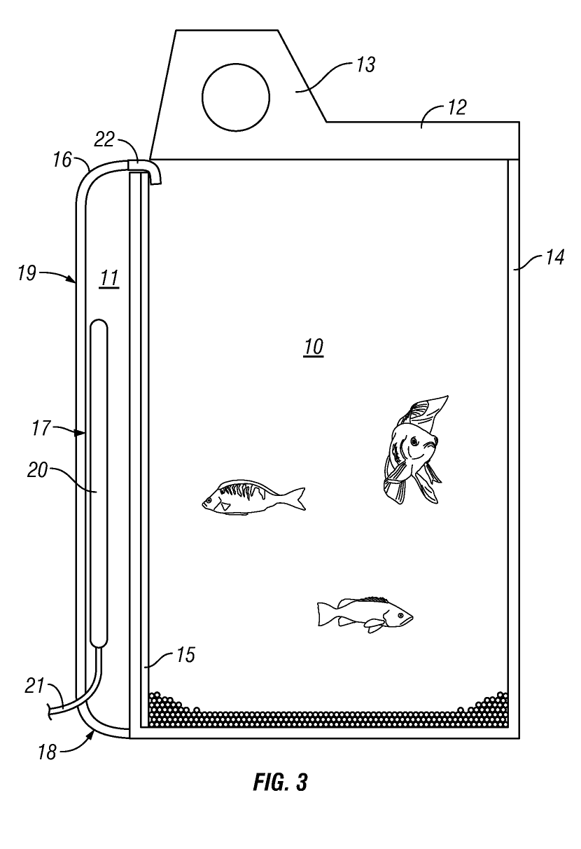

FIG. 1 shows a cross-sectional view of the illumination apparatus installed on an aquarium containing a water filter, according to one embodiment of the invention. Similarly, FIG. 3 shows the same view of the illumination apparatus, but without the water filter, where the filter is unnecessary as in embodiments where the apparatus is a terrarium, or other enclosure. The illumination apparatus can be fabricated from a variety of materials including, but not limited to, plastics, polymers, fiberglass, epoxies, resins, polycarbonates, molding compounds, glues, woods, glass, and metals. In one preferred embodiment, the animal feeder is made from opaque plastic, preferably black. The basic elements of the illumination apparatus are indicated in FIG. 1.

An exemplary aquarium is depicted in FIG. 1 that illustrates how the present invention is attached and where the illumination apparatus is in relationship to the aquarium, as in one preferred embodiment of the invention. A bottom and two sidewalls 14 define the interior of the aquarium space 10; the two other sidewalls of the aquarium are not depicted in this cross-section. An overhead lid 12 houses a light 13 that can provide illumination from the top of the aquarium. Overhead lids are well known in the art and commonly used in aquariums. A decorative scene 15 is affixed to the back wall of the aquarium. Such decorative scenes 15 are readily available and used frequently to enhance the aesthetic of the aquarium.

The present invention is an illumination apparatus that may be attached to the back wall, or another wall if desired, of the aquarium (or terrarium or similar enclosure if desired). The back wall of the illumination apparatus 19 is shown as one contiguous piece, with an upper edge 16 and lower edge 18 that are rounded. Edges to bring the illumination apparatus in connection with the aquarium, terrarium, or similar enclosure, on the sides are also provided, though not shown in this view. The wall 19 and edges 16, 18 are covered with a reflective material 17. The reflective material receives light waves from the illumination source 20, and redirects those waves through the wall of the aquarium 14, and the decorative scene 15 into the interior space 10. The reflective material 17 may be comprised of a variety of materials that are reflective including lightweight metals, fabrics, plastics, paints, and the like.

The illumination source 20 can be attached to an electrical source 21 to receive power. The illumination source 20 may receive power from other sources such as batteries, solar, etc., as is apparent to one skilled in the art. The illumination source 20 may be many things including fluorescent, incandescent, LED, plasma, or other illumination. More than one illumination source may be provided depending on the size of the area to be illuminated (i.e., where a large aquarium is being lit, two or three illumination sources may be used to achieve uniform illumination through the decorative scene in the enclosure). Alternatively, a plurality of small illumination sources may be used throughout the interior space of the illumination apparatus, as exemplified by lights attached by wire or contained within a sheath. The illumination source achieves uniform illumination through the back wall (or other wall where the present invention is attached) of the aquarium, terrarium, or similar enclosure, as in one preferred embodiment of the invention.

As is shown in FIG. 1, the illumination apparatus back wall 19 may be modified to accommodate a filter 24 where the enclosure to be illuminated is an aquarium. In FIG. 1 a second curve 25 in the back wall 19 allows for a thinner portion of the apparatus so that the water filter 24 may be placed on the back wall. Moreover, it should be noted that the thickness of the illumination apparatus (i.e., the distance between the back wall of the aquarium 14 and the back wall of the illumination apparatus 19) may vary. It may be advantageous to have a very thin illumination apparatus, which may be accomplished by using appropriate illumination sources (i.e., LED, phosphorescent, and plasma lighting), and/or thinner housing material (i.e., plastics in lieu of woods).

The illumination apparatus of the present invention can be attached to the aquarium, terrarium or similar enclosure by a variety of means. In one preferred embodiment, the illumination apparatus is attached via two hooks 22 on the upper corners of the illumination apparatus that fit onto the aquarium edge 14 (or terrarium, or similar enclosure as in other embodiments of the present invention). Other means of attaching the illumination apparatus are apparent to those skilled in the art and do not depart from the scope of the present invention. For example, the hook 22 could be contiguous along the length of the top edge of the illumination apparatus. Other adhesives, screws or means of affixing the illumination apparatus to the enclosure are contemplated.

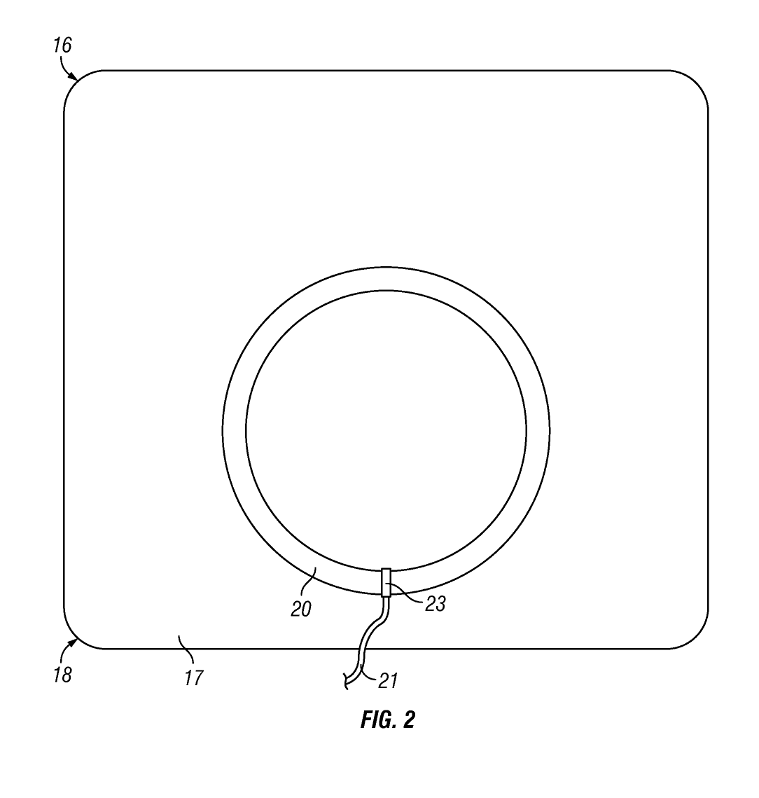

FIG. 2 provides a frontal view of the illumination apparatus, demonstrating the shape of the illumination source 20, as in one preferred embodiment of the invention. Other shapes such as straight, zigzag, spherical, or rectangular are contemplated and do not depart from the scope of the invention. In addition a plurality of small lighting sources may be employed. The plurality of small lighting sources may be connected to one another by a wire or contained within a plastic sheath. As stated above, where the space to be illuminated is sufficiently large, more than one illumination source may be used to accomplish a uniform illumination through the wall of the aquarium, terrarium or similar enclosure to which the present invention is attached. A connection 23 between the illumination source 20 and the electrical source 21 is also shown in FIG. 2. As is apparent to one skilled in the art, this connection 23 could also couple to a battery source or other energy source to activate the illumination source 20. The rounded edges 16, 18 are also depicted in FIG. 2, and allow for better reflection of the reflective material 17 into the aquarium, terrarium, or similar enclosure.

FIG. 3 is an additional cross-sectional view of the present invention attached to an aquarium, where no water filter is attached. In this figure, the back wall 19 of the illumination apparatus is of a consistent thickness with respect to the distance between the back wall 19 of the apparatus and the aquarium 14 to which it is attached.

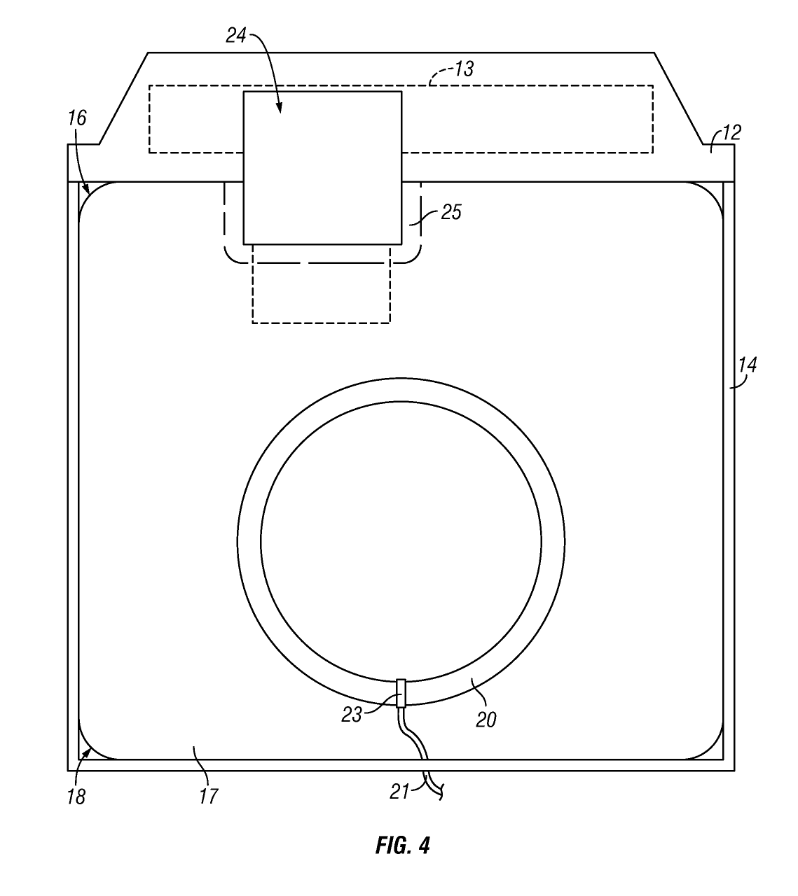

FIG. 4 is a back view of the illumination apparatus of the present invention attached to a wall of an aquarium. This view shows how the water filter 24 attached to the same wall of the aquarium 14 as the illumination apparatus. The back wall 19 of the illumination apparatus has deviations in its thickness (from the back wall 19 of the illumination apparatus to the aquarium) 25 to accommodate the water filter 24. The lighting 13 provided by the upper lid 12 of the aquarium is also shown. As shown in FIGS. 1 & 2, the edges 18, 16 of the illumination apparatus are rounded, as are the edges 25 that accommodate for the water filter 24. The back wall and edges of the illumination apparatus are covered in a reflective material 17. The illumination source 20 is shown, as well as the energy source 23 to the illumination source 20 and electrical cord 21.

Although the shape of the illumination apparatus is shown as rectangular, other shapes do not depart from the scope of the invention such as oval, square, circular, triangular, or rhomboid. The shape of the illumination apparatus is dependent on the shape of the enclosure to be illuminated.

I claim:

1. An illumination apparatus, capable of illuminating an enclosure, comprising a housing capable of being affixed to a wall containing a decorative scene of said enclosure and similar in shape to the wall of said enclosure where the illumination apparatus is to be affixed, wherein the inner surface of the housing contains a reflective material and at least one illumination source affixed to the back wall of the housing, the at least one illumination source being substantially large enough to uniformly illuminate the wall of enclosure to which the illumination apparatus is affixed.

2. An illumination apparatus, capable of illuminating an enclosure, comprising a housing capable of being affixed to a wall containing a decorative scene of said enclosure and similar in shape to the wall of said enclosure where the illumination apparatus is to be affixed, and of a thickness that allows a filter or other device to rest on top and over the illumination apparatus, wherein the inner surface of the housing contains a reflective material and at least one illumination source affixed to the back wall of the housing, the at least one illumination source being substantially large enough to uniformly illuminate the wall of enclosure to which the illumination apparatus is affixed.

3. An illumination apparatus for an aquarium, comprising a housing capable of being affixed by the use of two hooks to a wall of said aquarium, said aquarium containing a decorative scene on a wall of the aquarium where the illumination apparatus is affixed, said illumination apparatus being similar in shape to said wall of said aquarium where the illumination apparatus is affixed, where the inner surface of the housing is comprised of a reflective material and contains at least one illumination source affixed to the back wall of the housing that is capable of uniform illumination of said wall of enclosure to which the illumination apparatus is affixed.

4. The illumination apparatus of claim 1, 2, or 3, wherein the illumination source is a circular fluorescent light that is near in size to the housing and capable of providing uniform illumination of the enclosure or aquarium.

5. The illumination apparatus of claim 1, 2, or 3, wherein the shape of the illumination source is straight, circular, rectangular, or zigzag within the housing and capable of providing uniform illumination of the enclosure or aquarium.

6. The illumination apparatus of claim 1, 2, or 3, wherein the illumination source is incandescent, phosphorescent, plasma or LED.

7. The illumination apparatus of claim 1, 2, or 3, wherein the illumination source is a plurality of small lights connected by wire or by sheath and arranged within the housing to as to provide a uniform distribution of light to the enclosure or aquarium.

8. The illumination apparatus of claim 1 or 3, wherein the housing is of a minimal thickness so as to accommodate a standard water filter used in an aquarium.

9. The illumination apparatus of 1, 2, or 3, wherein the housing is of a suitable shape to illuminate said enclosure or aquarium where its shape is cylindrical, or oval.
